(19) United States
(12) Patent Application Publication
(10) Pub. No.: US 2026/0331080 A1
(43) Pub. Date: Oct. 22, 2026

(54) FOOTBOARD MECHANISM OF MUSICAL INSTRUMENT DRUM

(71) Applicant: K.H.S. MUSICAL INSTRUMENT CO., LTD., New Taipei City (TW)

(72) Inventor: CHIH-CHIEH CHIAO, New Taipei City (TW)

(73) Assignee: K.H.S. MUSICAL INSTRUMENT CO., LTD., New Taipei City (TW)

(21) Appl. No.: 19/186,097

(22) Filed: Apr. 22, 2025

(51) Int. Cl. G10D 13/11

(52) U.S. Cl. CPC G10D 13/11

(57) ABSTRACT

The invention provides a footboard mechanism for a musical instrument drum, the mechanism comprises: a support base, a shaft, two bearings and a footboard. The support base has a bottom plate and a shaft support, and the shaft is disposed in a shaft hole of the shaft support, so that two ends of the shaft protrude from the shaft support to form a left protruding portion, a central portion and a right protruding portion in sequence. The bearings are respectively assembled on the left and right protruding portion. The footboard has a board and a cover; a left space and a right space are formed between the board and the cover. Therefore, the bearings are positioned respectively in the left and right space without shifting. When the footboard is pivoted close to or away from the support base, the bearings can reduce shake of the footboard.

### FIELD OF THE INVENTION

The invention relates to a footboard mechanism for a percussion instrument drum, and in particular to a footboard mechanism that can clamp a bearing between a board and a cover to reduce the chance of the bearing being moved, thereby reducing the shaking generated when the footboard mechanism is stepped on.

### BACKGROUND OF THE INVENTION

A common jazz drum is composed of a plurality of drums with different timbres, at least one percussion instrument, and a footboard mechanism. The footboard mechanism has a pedal and a drumstick, and an operator can use both hands to hold the drumstick and use the feet to step on the pedal at the same time, so that a drumrod and the drumstick can strike different drum surfaces at the same time, thereby allowing the operator to use both hands and feet to strike a plurality of musical instrument drums at the same time.

The footboard mechanism of the musical instrument drum usually has a base in contact with the ground and a footboard assembled and connected to the base, and the footboard is provided for the operator to step on so that the drumstick connected to the footboard can be moved away from or strike the drum surface. However, the base and the footboard are often assembled and connected by springs, screws or other locking elements, so that there is a gap between the base and the footboard. Thus, when the operator steps on the footboard, the footboard will shake left and right, making it impossible to stably actuate the footboard.

### SUMMARY OF THE INVENTION

A main objective of the invention is to improve a structural pattern of a footboard assembled and connected to a support base, so that two bearings can be clamped between a board and a cover, the bearings are allowed to be positioned in a left space or a right space, and in turn the board can be stably pivoted close to or away from a bottom plate through the bearings, which can relatively reduce the chance of shaking the footboard mechanism when the footboard mechanism is actuated.

A secondary objective of the invention is to improve a structural pattern of a footboard mechanism so that a shaft has a central portion of a polygonal column and circular columns disposed on two different sides of the central portion. Thus, when the board rotates relative to the bottom plate, the central portion of the shaft will be fixed by a second screw and cannot rotate relative to the bottom plate, and the circular columns of the shaft will rotate along with the bearings.

To achieve the aforementioned objectives, the invention relates to a footboard mechanism for a musical instrument drum, which includes a support base, a shaft, two bearings and a footboard.

In a first preferred embodiment, the support base has a bottom plate and an shaft support located at a rear end of the bottom plate, the shaft support has an shaft hole, a first screw hole, a second screw hole, a fixing portion and a pivot portion. The first screw hole can match with a first screw, the second screw hole can match with a second screw, and the pivot portion is laterally connected to the fixing portion, so that side ends of the shaft support together form an L-shaped section, also the second screw hole is communicated with the shaft hole, and thus the shaft is fixed by the second screw without rotating relative to the shaft support, where the shaft support and the bottom plate are fixed by the first screw, and the shaft support and the shaft are positioned by the second screw.

However, the shaft is disposed in the shaft hole so that both ends of the shaft protrude from the shaft support to sequentially form a left protruding portion, a central portion and a right protruding portion, and two bearings are respectively assembled on the left protruding portion and the right protruding portion of the shaft.

Further, the footboard has a board and a cover located below the board. A left space and a right space are formed between the board and the cover, and the cover is detachably connected to the board, so that one of the bearings is clamped in the left space and the other of the bearings is clamped in the right space.

In the first preferred embodiment, the cover includes two cover bodies and two countersunk screws, the cover bodies are mirror arranged and fixed on two opposite sides of the board by the two countersunk screws, so that the cover bodies are spaced each other. Each of the cover bodies includes an opening portion matched with the countersunk screw and a clamping portion aligned with the shaft hole, the clamping portion is provided with a recess adjacent to the shaft hole and a flange shielding the shaft hole, and the recess has a first semicircular groove and a second semicircular groove with a radius smaller than that of the first semicircular groove. The first semicircular groove contacts the bearing, and the second semicircular groove accommodates one of the left protruding portion and the right protruding portion.

Moreover, a left recess portion and a right recess portion are disposed at a bottom end of the board. The left recess portion matches with the recess and the flange to form the left space collectively, and the right recess portion matches with the recess and the flange to form the right space collectively.

Further, the cover body further includes a positioning portion, so that the positioning portion and the clamping portion are respectively located on two opposite sides of the opening portion, the positioning portion is configured as a convex column inserted into the board, and thus the cover body can quickly and accurately abut against a set position under the board through both the convex column and the flange.

In a second preferred embodiment, the central portion of the shaft is configured as a polygonal column, and the left protruding portion and the right protruding portion of the shaft are each configured as the circular column, and the second screw enters the shaft hole to press against one of the planes of the polygonal column.

In a third preferred embodiment, the footboard mechanism of the musical instrument drum includes the footboard, the shaft, the two bearings and the support base. The footboard has the board and the shaft support located below the board. The shaft support has the shaft hole, and the shaft is disposed in the shaft hole, so that two ends of the shaft protrude from the shaft support to sequentially form the left protruding portion, the central portion and the right protruding portion, the bearings are respectively assembled on the left protruding portion and the right protruding portion of the shaft, and the support base has the bottom plate and the cover located at a rear end of the bottom plate. The left space and the right space are formed between the bottom plate and the cover, and the cover is detachably connected to the board, so that one of the bearings is clamped in the left space, and the other of the bearings is clamped in the right space.

The present invention is characterized in that the footboard mechanism of the musical instrument drum has a shaft support, a shaft and two bearings. The shaft support is assembled and connected to the support base, the shaft is disposed in the shaft hole of the shaft support, the bearings are respectively assembled at two opposite ends of the shaft, a left space and a right space are formed between the board and the cover, and the cover is detachably connected to the board, so that one of the bearings is clamped in the left space and the other of the bearings is clamped in the right space, also the shaft support has a first screw hole matched with a first screw and a second screw hole matched with a second screw, the shaft support and the bottom plate of the support base are locked and fixed by the first screw, and the second screw hole is communicated with the shaft hole, so that the second screw enters the shaft hole to press against the shaft, in turn the shaft support and the shaft are stopped and positioned by the second screw, and thus the shaft is fixed by the second screw without rotating relative to the shaft support. Thereby, the bearings can be clamped between the support base and the footboard to be respectively disposed in the left space or the right space, so that the bearings are positioned respectively in the left space and the right space without shifting. When the footboard is pivoted close to or away from the support base, the bearings can reduce shake of the footboard.

### BRIEF DESCRIPTION OF THE DRAWINGS

FIG. 1 is a schematic diagram of a footboard mechanism for a musical instrument drum in a first preferred embodiment of the invention;

FIG. 2 is an exploded view of the footboard mechanism for a musical instrument drum in the first preferred embodiment of the invention;

FIG. 3 is a cross-sectional view of the footboard mechanism for a musical instrument drum in the first preferred embodiment;

FIG. 4 is a schematic diagram of a support base in the first preferred embodiment;

FIG. 5 is a schematic diagram of a footboard in the first preferred embodiment;

FIG. 6 is a schematic diagram of a cover in the first preferred embodiment;

FIG. 7 is a schematic diagram of the footboard away from the support base in the first preferred embodiment;

FIG. 8 is a schematic diagram of a shaft support, a bearing, a shaft and a cover in the first preferred embodiment;

FIG. 9 is a cross-sectional view of the shaft support, the shaft and a second screw in the first preferred embodiment;

FIG. 10 is an exploded view of a footboard mechanism for a musical instrument drum in a second preferred embodiment;

FIG. 11 is a cross-sectional view of a shaft support, a shaft and a second screw in the second preferred embodiment;

FIG. 12 is a schematic diagram of a footboard mechanism for a musical instrument drum in a third preferred embodiment;

FIG. 13 is a schematic diagram of a support base in the third preferred embodiment; and

FIG. 14 is a schematic diagram of a footboard in the third preferred embodiment.

### DETAILED DESCRIPTION OF THE PREFERRED EMBODIMENTS

In order to have further clear and detailed knowledge and understanding of the construction, use and features of the invention, preferred embodiments are given and described in detail with reference to the drawings as follows:

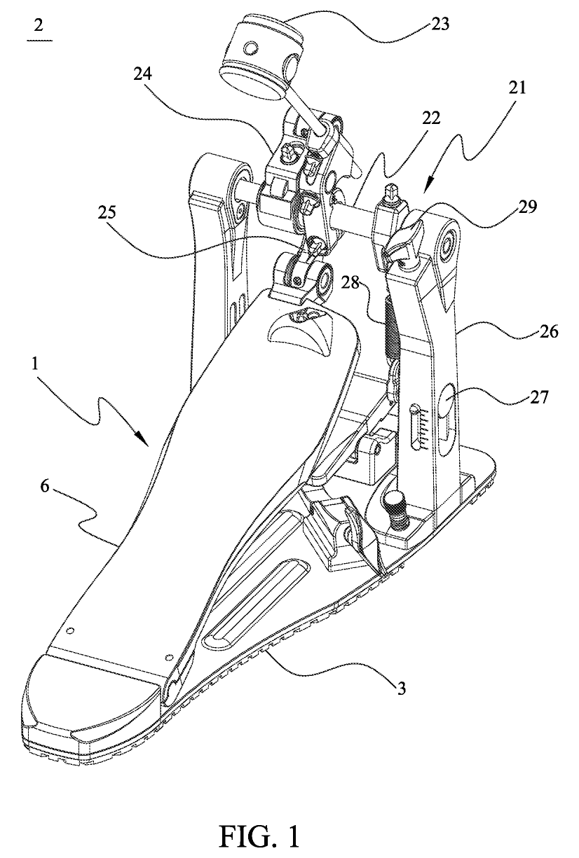

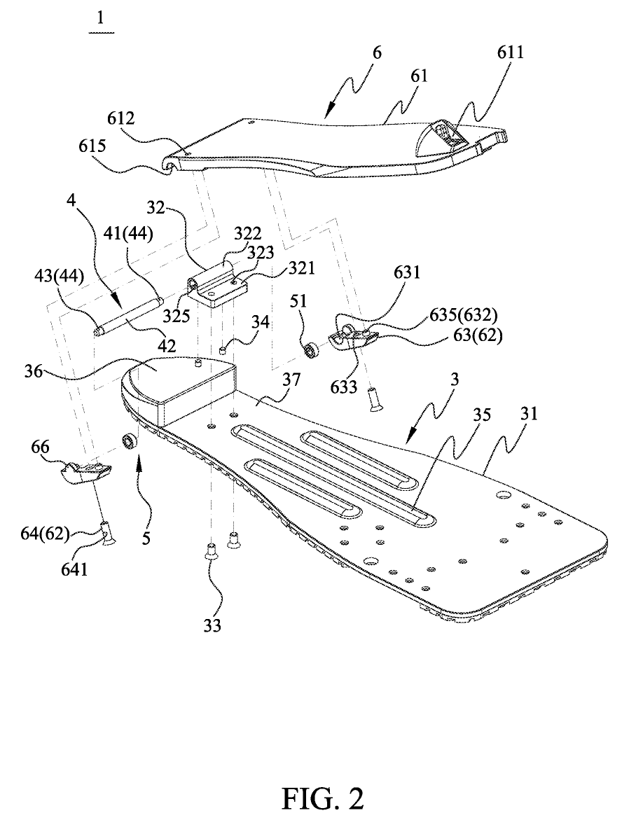

Referring to FIGS. 1 and 2, in a first preferred embodiment, a footboard mechanism 1 for a musical instrument drum of the invention is assembled on a treading drumstick device 2 of a jazz drum, and the treading drumstick device 2 of the jazz drum further includes a spring elastic-force adjustment device 21, a rotating shaft 22, a drumstick 23, a pivoting portion 24 and a driving member 25. The spring elastic-force adjustment device 21 includes a positioning bracket 26, an adjusting member 27, a spring assembly 28 and an operating handle 29. The adjusting member 27 and the operating handle 29 are respectively assembled and connected with the positioning bracket 26, and the spring assembly 28 is assembled and connected between the positioning bracket 26 and the adjusting member 27. Moreover, the rotating shaft 22 is respectively assembled and connected with the positioning bracket 26, the drumstick 23 and the pivoting portion 24, and the driving member 25 is assembled and connected between the pivoting portion 24 and the footboard mechanism 1.

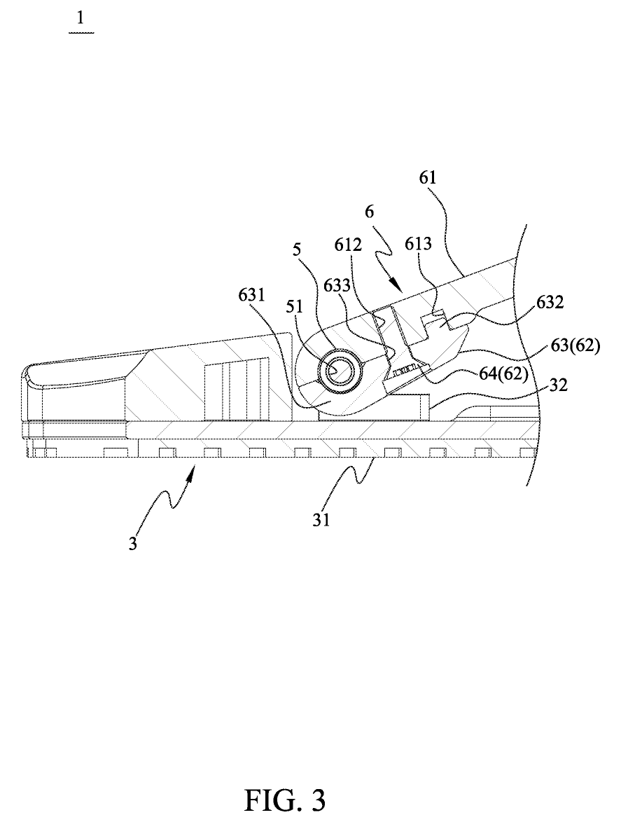

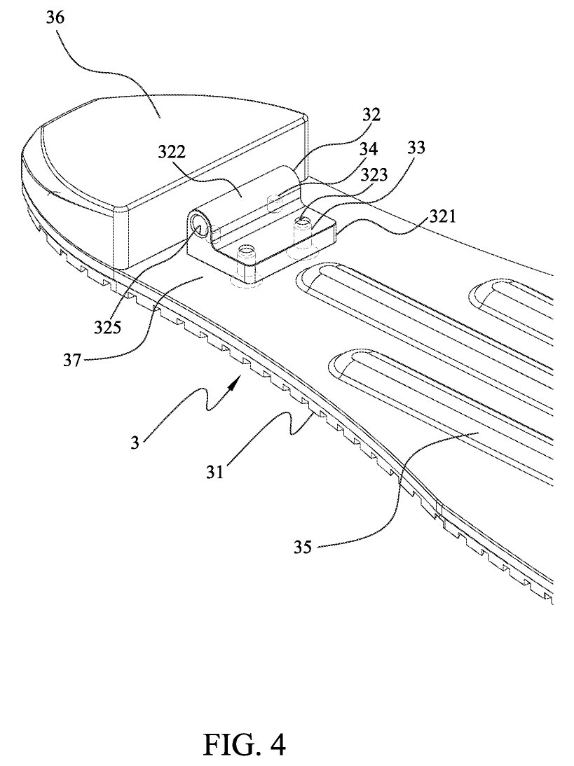

Referring to FIGS. 1, 2, 3 and 4, in the first preferred embodiment, the footboard mechanism 1 for the musical instrument drum is mainly composed of a support base 3, a shaft 4, two bearings 5 and a footboard 6. The support base 3 has a bottom plate 31, a shaft support 32, a first screw 33 and a second screw 34. The bottom plate 31 has a plurality of convex ribs 35, a heel plate portion 36 and a locking hole portion 37 disposed between the plurality of convex ribs 35 and the heel plate portion 36. The heel plate portion 36 is disposed at a rear end of the bottom plate 31. The plurality of convex ribs 35 and the heel plate portion 36 both protrude from a surface of the bottom plate 31, and the plurality of convex ribs 35 are parallel to each other.

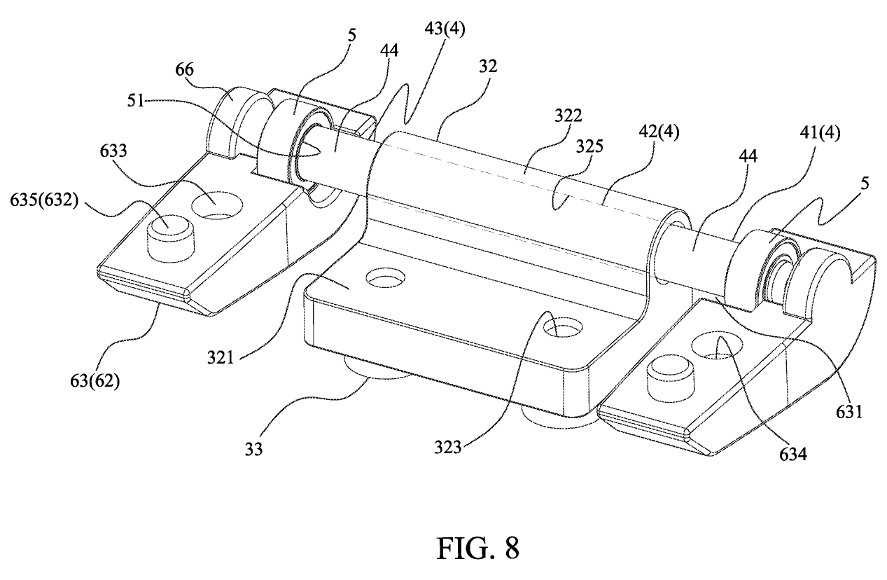

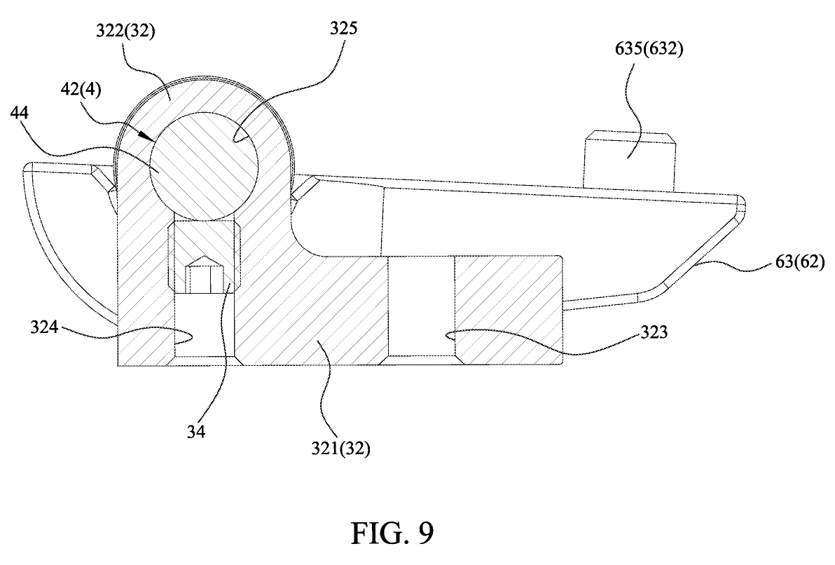

Referring to FIGS. 2, 4, 7, 8 and 9, in the first preferred embodiment, the shaft support 32 has a fixing portion 321 and a pivoting portion 322 transversely connected to the fixing portion 321, so that the side ends of the shaft support 32 together form an L-shaped section, and the fixing portion 321 has two first screw holes 323 and two second screw holes 324, where each of the first screw holes 323 is provided for insertion of the first screw 33 and each of the second screw holes 324 is provided for insertion of the second screw 34. The pivoting portion 322 has a shaft hole 325. The shaft hole 325 is disposed above the two second screw holes 324, the shaft hole 325 is communicated with the two second screw holes 324, and the second screw hole 324 is perpendicular to the shaft hole 325, where the two first screw holes 323 are aligned with the locking hole portion 37 of the bottom plate 31, and the first screw 33 is inserted into the locking hole portion 37 of the bottom plate 31 and the first screw hole 323 in sequence, so that the shaft support 32 is assembled and connected to the bottom plate 31, the shaft support 32 and the bottom plate 31 are locked and fixed by the first screw 33, and in turn the shaft support 32 is fixed to the rear end of the bottom plate 31. However, there is no limitation on the structural pattern of the first screw 33 and the second screw 34. The first screw 33 may be a countersunk screw, and the second screw 34 may be a stop screw.

Referring to FIGS. 2, 7, 8 and 9, in the first preferred embodiment, the shaft 4 is inserted into the shaft hole 325 of the shaft support 32, so that the two opposite ends of the shaft 4 protrude from the shaft support 32 respectively, and in turn the shaft 4 is sequentially provided with a left protruding portion 41, a central portion 42 and a right protruding portion 43, so that the central portion 42 is disposed between the left protruding portion 41 and the right protruding portion 43. The left protruding portion 41, the central portion 42 and the right protruding portion 43 are each configured as a circular column 44. The diameter of the left protruding portion 41 is the same as that of the right protruding portion 43, and the diameter of the left protruding portion 41 is smaller than that of the central portion 42. The second screw 34 is sequentially inserted into the second screw hole 324 and the shaft hole 325, until an end of the second screw 34 contacts the central portion 42 of the shaft 4 and stops, so that the shaft 4 and the shaft support 32 are stopped and positioned by the second screw 34, and in turn the shaft 4 can be fixed by the second screw 34 and cannot rotate relative to the shaft support 32.

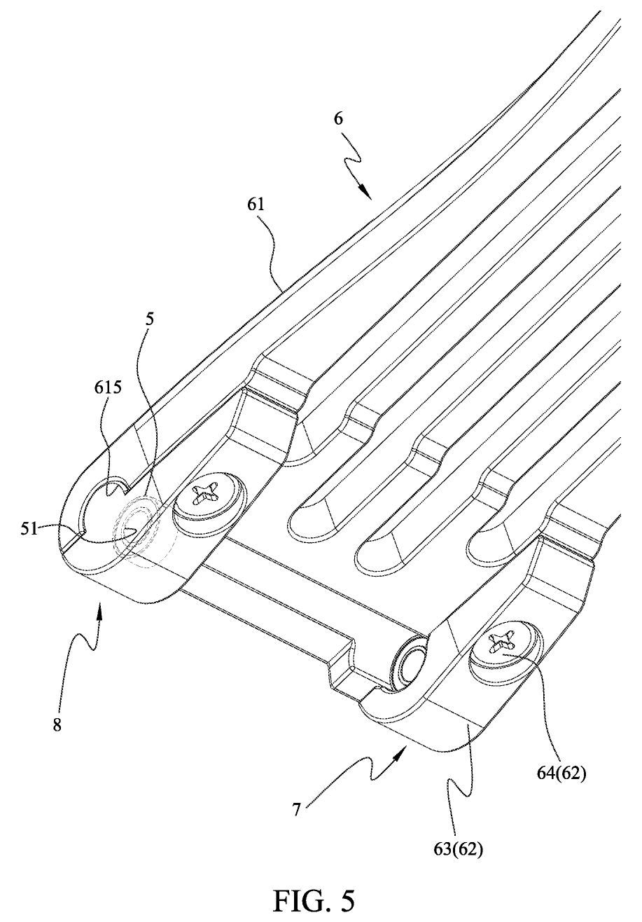

Referring to FIGS. 2, 3, 5, 7, 8 and 9, in the first preferred embodiment, the bearing 5 has a circular hole 51 therein, and the bearings 5 are respectively assembled on the left protruding portion 41 and the right protruding portion 43 of the shaft 4, so that the circular hole 51 of the bearing 5 is annularly arranged around the outer periphery of the left protruding portion 41, and the circular hole 51 of the other bearing 5 is annularly arranged around the outer periphery of the right protruding portion 43, causing there is a gap between the bearing 5 and the shaft 4.

Referring to FIGS. 1, 2, 3, 5, 6, 7 and 8, in the first preferred embodiment, the footboard 6 has a board 61 and a cover 62 located below the board 61, and the board 61 has a connecting portion 611, a perforated portion 612, a groove portion 613, a left recess portion 614 and a right recess portion 615. The connecting portion 611 and the perforated portion 612 are respectively disposed on two opposite sides of the board 61, so that the connecting portion 611 is disposed at a top end of the board 61 to connect with the driving member 25, and the perforated portion 612, the groove portion 613, the left recess portion 614 and the right recess portion 615 are all disposed at a bottom end of the board 61, and the cover 62 includes two cover bodies 63 and two countersunk screws 64. Furthermore, the cover body 63 includes a clamping portion 631, a positioning portion 632 , and an opening portion 633 disposed between the clamping portion 631 and the positioning portion 632. An inner contour 634 of the opening portion 633 can match an outer contour 641 of the countersunk screw 64. In this embodiment, the clamping portion 631 is provided with a recess 65 adjacent to the shaft hole 325 and a flange 66 adjacent to the recess 65. The recess 65 has a first semicircular groove 651 and a second semicircular groove 652 having a radius smaller than that of the first semicircular groove 651, and the second semicircular groove 652 is disposed between the first semicircular groove 651 and the flange 66. The first semicircular groove 651 is provided for accommodation for the bearing 5, and the second semicircular groove 652 accommodates one of the left protruding portion 41 or the right protruding portion 43. However, the left recess portion 614 can match with the recess 65 and the flange 66 to together form a left space 7, and the right recess portion 615 can match with the recess 65 and the flange 66 to together form a right space 8, so that the left space 7 and the right space 8 are formed between the board 61 and the cover 62. Moreover, the clamping portion 631 is aligned with the shaft hole 325, so that the flange 66 can shield the shaft hole 325, and thus the outer periphery of one of the bearings 5 can contact the first semicircular groove 651 and the left recess portion 614, and the outer periphery of the other of the bearings 5 can contact the first semicircular groove 651 and the right recess portion 615, and in turn one of the bearings 5 is clamped in the left space 7 and the other of the bearings 5 is clamped in the right space 8.

Referring to FIGS. 2, 3, 6, 7, 8 and 9, in the first preferred embodiment, the positioning portion 632 and the clamping portion 631 are respectively located on two opposite sides of the opening portion 633. The positioning portion 632 is configured as a convex column 635. The convex column 635 is inserted into the groove portion 613 of the board 61, so that the two flanges 66 can contact the left recess portion 614 and the right recess portion 615 of the board 61, respectively. The countersunk screw 64 is sequentially inserted into the opening portion 633 of the cover body 63 and the perforated portion 612 of the board 61, the cover body 63 is detachably connected to the board 61, and the two cover bodies 63 can be fixed on two opposite sides of the board 61 by the two countersunk screws 64, so that the two cover bodies 63 can be spaced apart and mirror-arranged on the left and right sides of the board 61, and in turn the cover bodies 63 can be quickly and accurately clamped at a set position below the board 61 through the convex column 635 of the positioning portion 632 and the flange 66 of the clamping portion 631. Thereby, the board 61 can be stably pivoted close to or away from the bottom plate 31 through the bearings 5, which can relatively reduce the chance of shaking of the footboard mechanism 1 when it is actuated.

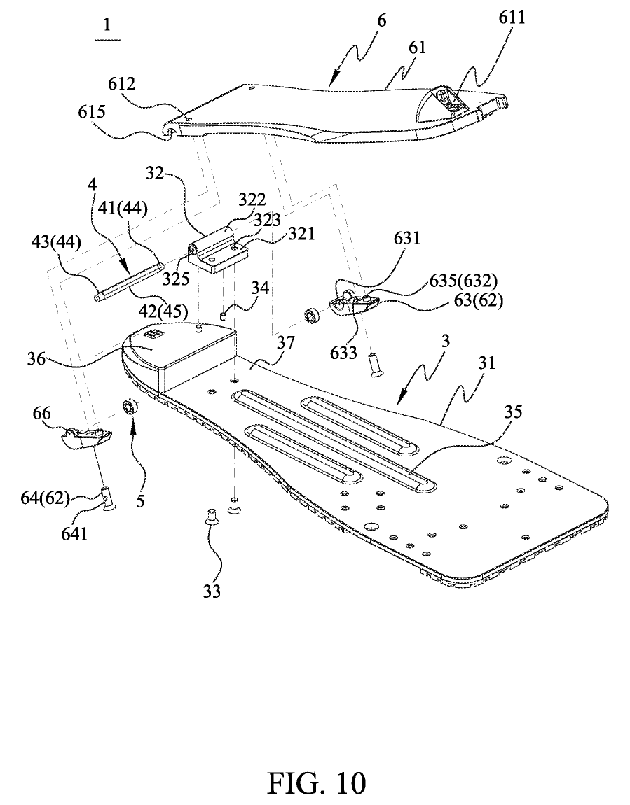

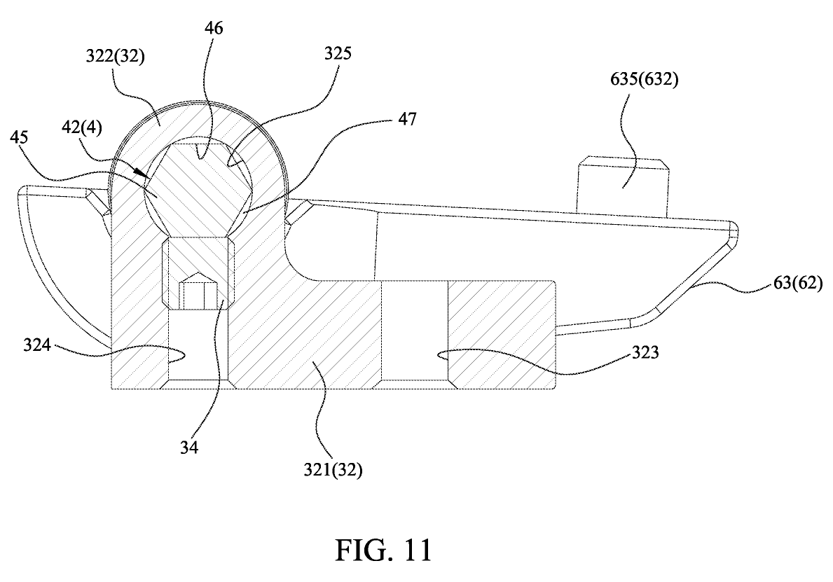

Referring to FIGS. 10 and 11, in a second preferred embodiment, the difference of it from the first preferred embodiment lies in the structural pattern of the shaft 4, and the structural patterns of the support base 3, the bearings 5 and the footboard 6 are the same as those in the first preferred embodiment. Therefore, in this embodiment, the structural patterns of the support base 3, the bearings 5 and the footboard 6 will not be repeatedly described herein.

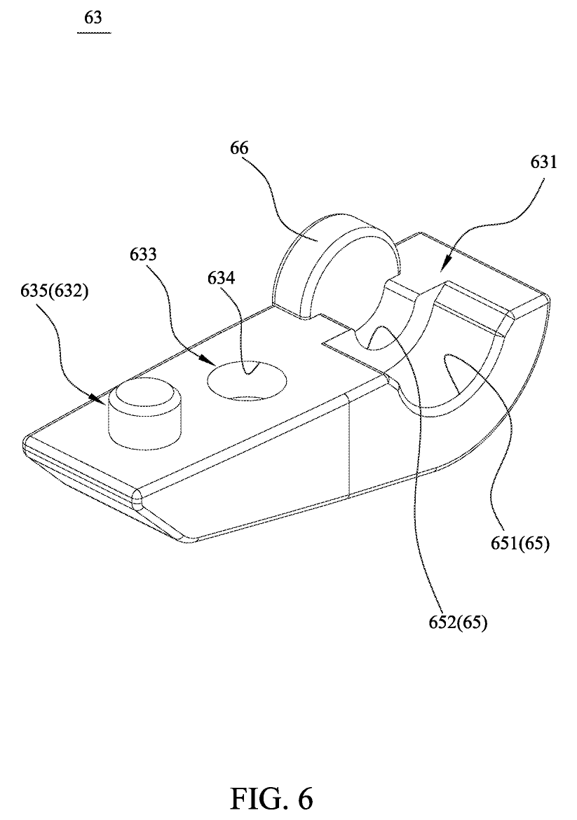

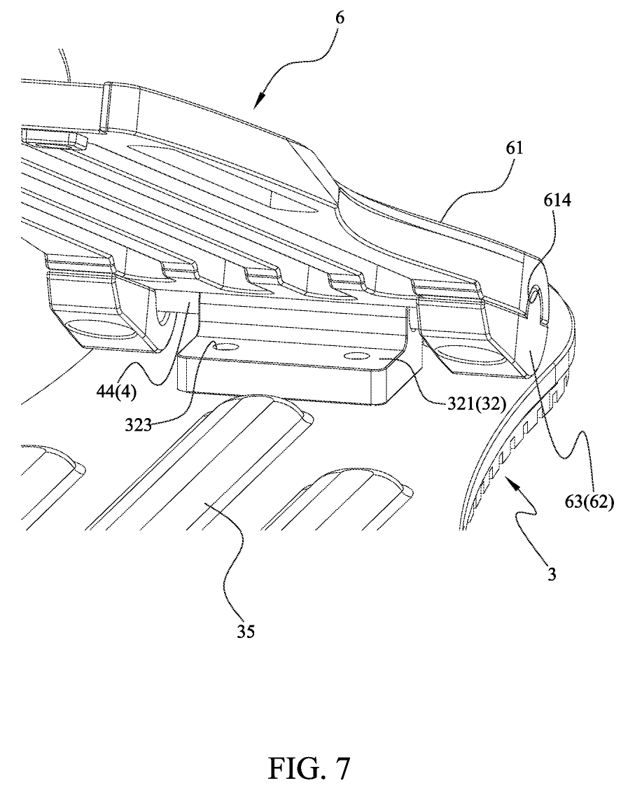

Continually referring to FIGS. 6 and 7, in the second preferred embodiment, the shaft 4 has the left protruding portion 41, the right protruding portion 43, and the central portion 42 disposed between the left protruding portion 41 and the right protruding portion 43. The left protruding portion 41 and the right protruding portion 43 are each configured as the circular column 44, and the central portion 42 is configured as a polygonal column 45. The second screw 34 is sequentially inserted into the second screw hole 324 and the shaft hole 325, until the end of the second screw 34 contacts the central portion 42 of the shaft 4 and stops, so that the second screw 34 is pressed against one of the planes 46 of the polygonal column 45, and thus the end of the second screw 34 can continuously contact the plane 46, and the shaft 4 cannot rotate relative to the shaft support 32. When the shaft 4 penetrates the shaft hole 325 of the shaft support 32, a part of the central portion 42 will contact the inner periphery of the shaft hole 325 and the remaining part of the central portion 42 will produce a gap 47 with the inner periphery of the shaft hole 325, so that the shaft 4 and the shaft support 32 are stopped and positioned by the second screw 34, and thus the shaft 4 can be fixed by the second screw 34 and cannot rotate relative to the shaft support 32.

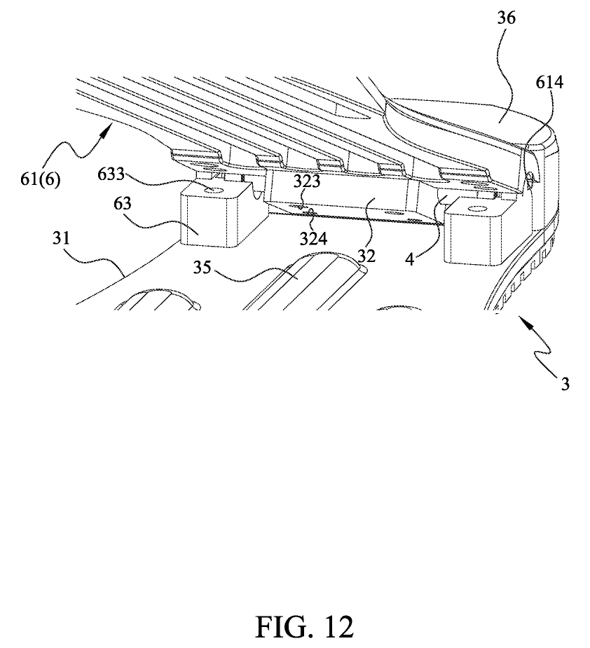

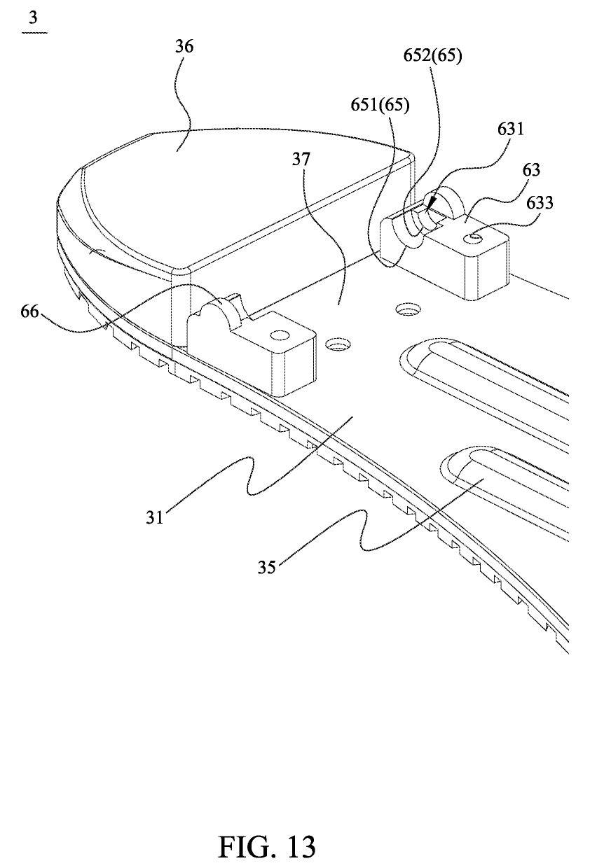

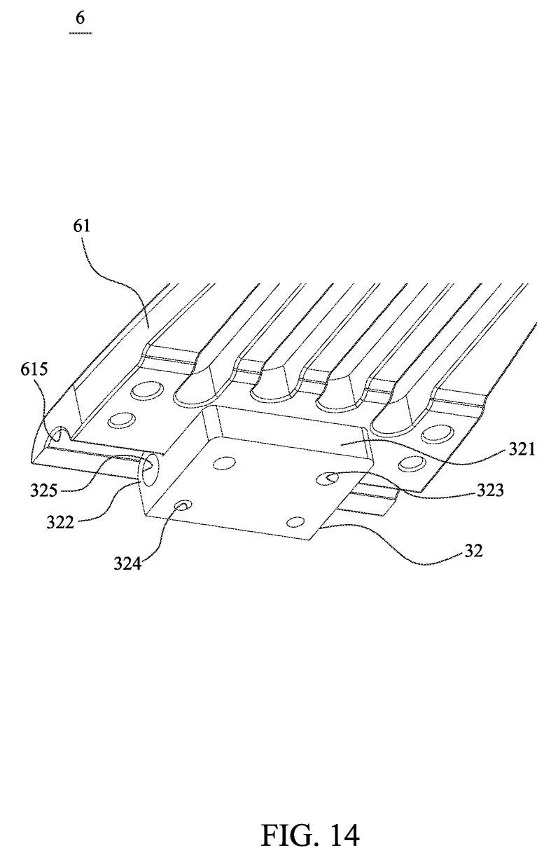

Referring to FIGS. 12, 13 and 14, in a third preferred embodiment, the difference of it from the first preferred embodiment lies in the structural pattern of the support base 3 and the footboard 6, and the structural patterns of the shaft 4 and the bearings 5 are the same as those in the first preferred embodiment. Therefore, in this embodiment, the structural patterns of the shaft 4 and the bearings 5 will not be repeatedly described herein. In the third preferred embodiment, the support base 3 has the bottom plate 31 and the cover 62 located at a rear end of the bottom plate 31. The bottom plate 31 has the plurality of convex ribs 35, the heel plate portion 36, and the locking hole portion 37 disposed between the plurality of convex ribs 35 and the heel plate portion 36. The cover 62 includes the two cover bodies 63 and the two countersunk screws 64. The cover body 63 has the clamping portion 631 and the opening portion 633. The clamping portion 631 is provided with the recess 65 adjacent to the shaft hole 325 and the flange 66 adjacent to the recess 65. The recess 65 has the first semicircular groove 651 and the second semicircular groove 652 having a radius smaller than that of the first semicircular groove 651. The second semicircular groove 652 is disposed between the first semicircular groove 651 and the flange 66. The first semicircular groove 651 is provided for accommodation for the bearing 5. The second semicircular groove 652 accommodates one of the left protruding portion 41 of the bearing 5 and the right protruding portion 43 of the bearing 5. However, the left recess portion 614 can match with the recess 65 and the flange 66 to together form the left space 7, and the right recess portion 615 can match with the recess 65 and the flange 66 to together form the right space 8, so that the left space 7 and the right space 8 are formed between the bottom plate 31 and the cover 62. Moreover, the clamping portion 631 is aligned with the shaft hole 325, so that the flange 66 can shield the shaft hole 325, so that the outer periphery of one of the bearings 5 can contact the first semicircular groove 651 and the left recess portion 614, and the outer periphery of the other of the bearings 5 can contact the first semicircular groove 651 and the right recess portion 615, and in turn one of the bearings 5 is clamped in the left space 7 and the other of the bearings 5 is clamped in the right space 8. The two countersunk screws 64 are sequentially inserted into the opening portion 633 and the bottom plate 31, so that the cover body 63 is detachably connected to the bottom plate 31, and the two cover bodies 63 can be fixed on two opposite sides of the bottom plate 31 by the two countersunk screws 64.

Continually referring to FIGS. 12, 13 and 14, in the third preferred embodiment, the footboard 6 has the board 61, the shaft support 32, the first screw 33 and the second screw 34. The board 61 has the connecting portion 611, the perforated portion 612, the left recess portion 614 and the right recess portion 615. The left recess portion 614 and the right recess portion 615 are both disposed at the bottom end of the board 61. The shaft support 32 has the fixing portion 321 and the pivoting portion 322 laterally connected to the fixing portion 321. The fixing portion 321 has the two first screw holes 323 and the two second screw holes 324. Each of the first screw holes 323 is provided for insertion of the first screw 33 and each of the second screw holes 324 is provided for insertion of the second screw 34. The pivoting portion 322 has the shaft hole 325. The shaft hole 325 is disposed above the two second screw holes 324, the shaft hole 325 is communicated with the two second screw holes 324, and the second screw hole 324 is perpendicular to the shaft hole 325. The two first screw holes 323 are aligned with the perforated portion 612 of the board 61, and the first screw 33 is sequentially inserted into the perforated portion 612 of the board 61 and the first screw hole 323, so that the shaft support 32 is assembled and connected with the board 61, and the shaft support 32 and the board 61 are locked and fixed by the first screw 33, and in turn the shaft support 32 is fixed to the rear end of the board 61.

What is claimed is:

1. A footboard mechanism for a musical instrument drum, comprising:
a support base having a bottom plate and an shaft support located at a rear end of the bottom plate, the shaft support having a shaft hole;
a shaft being disposed in the shaft hole, and two ends of the shaft protrude from the shaft support to sequentially form a left protruding portion, a central portion and a right protruding portion;
two bearings being respectively assembled on the left protruding portion and the right protruding portion of the shaft; and
a footboard having a board and a cover located below the board, wherein a left space and a right space are formed between the board and the cover, and the cover is detachably connected to the board so that one of the bearings is clamped in the left space and the other of the bearings is clamped in the right space.

2. The footboard mechanism for a musical instrument drum according to claim 1, wherein the shaft support and the bottom plate are fixed by a first screw, and the shaft support and the shaft are positioned by a second screw.

3. The footboard mechanism for a musical instrument drum according to claim 2, wherein the shaft support is provided with a first screw hole matched with the first screw and a second screw hole matched with the second screw, and the second screw hole is communicated with the shaft hole, so that the shaft is fixed by the second screw without rotating relative to the shaft support.

4. The footboard mechanism for a musical instrument drum according to claim 3, wherein the central portion of the shaft is configured as a polygonal column, and the left protruding portion and the right protruding portion are each configured as a circular column, and the second screw pass through the second screw hole and the shaft hole to press against a plan of the polygonal column.

5. The footboard mechanism for a musical instrument drum according to claim 1, wherein the cover comprises two cover bodies and two countersunk screws, the cover bodies are mirror arranged and fixed on two opposite sides of the board by the two countersunk screws, so that the cover bodies are spaced each other.

6. The footboard mechanism for a musical instrument drum according to claim 5, wherein each of the cover bodies comprises an opening portion matched with the countersunk screw and a clamping portion aligned with the shaft hole, and the clamping portion is provided with a recess adjacent to the shaft hole and a flange shielding the shaft hole.

7. The footboard mechanism for a musical instrument drum according to claim 6, wherein the cover bodies further comprise a positioning portion, the positioning portion and the clamping portion are respectively located on two opposite sides of the opening portion, the positioning portion is configured as a convex column inserted into the board, and thus the cover bodies are capable of quickly and accurately abutting against a target position under the board through both the convex column and the flange.

8. The footboard mechanism for a musical instrument drum according to claim 6, wherein the recess has a first semicircular groove and a second semicircular groove having a radius smaller than that of the first semicircular groove, the first semicircular groove contacts the bearing, and the second semicircular groove accommodates one of the left protruding portion and the right protruding portion.

9. The footboard mechanism for a musical instrument drum according to claim 6, wherein the board is provided with a left recess portion and a right recess portion on the bottom end, the left recess portion matches with the recess and the flange to form the left space collectively, and the right recess portion matches with the recess and the flange to form the right space collectively.

10. A footboard mechanism for a musical instrument drum, comprising:
a footboard having a board and an shaft support located below the board, wherein the shaft support has an shaft hole;
a shaft being disposed in the shaft hole so that two ends of the shaft protrude from the shaft support to sequentially form a left protruding portion, a central portion and a right protruding portion;
two bearings being respectively assembled on the left protruding portion and the right protruding portion of the shaft; and
a support base having a bottom plate and a cover located at a rear end of the bottom plate, wherein a left space and a right space are formed between the bottom plate and the cover, and the cover is detachably connected to the board so that one of the bearings is clamped in the left space and the other of the bearings is clamped in the right space.
